(19) United States
(12) Patent Application Publication
(10) Pub. No.: US 2022/0055653 A1
(43) Pub. Date: Feb. 24, 2022

(54) INFORMATION PROCESSING DEVICE, METHOD OF INFORMATION PROCESSING, AND PROGRAM

(71) Applicant: TOYOTA JIDOSHA KABUSHIKI KAISHA, Toyota-shi (JP)

(72) Inventors: Toshinari OGAWA, Nogoya-shi (JP); Kohta TARAO, Nogoya-shi (JP); Shinya KIJIMA, Nogoya-shi (JP); Osamu FUKAWATASE, Miyoshi-shi (JP); Koji YASUI, Toyota-shi (JP); Toshiyuki KOBAYASHI, Miyoshi-shi (JP); Hitomi NAKATANI, Toyota-shi (JP); Kuniaki JINNAI, Nagoya-shi (JP); Akihiro ITO, Shinagawa-ku (JP); Nobuki HAYASHI, Nisshin-shi (JP); Masahiro NAGANO, Toyota-shi (JP)

(73) Assignee: TOYOTA JIDOSHA KABUSHIKI KAISHA, Toyota-shi (JP)

(21) Appl. No.: 17/362,036

(22) Filed: Jun. 29, 2021

(30) Foreign Application Priority Data
Aug. 24, 2020 (JP) 2020-140740

(51) Int. Cl. B60W 60/00; G08G 1/00; H04W 4/029

(52) U.S. Cl. CPC B60W 60/001; H04W 4/029; G08G 1/202

(57) ABSTRACT

An information processing device is configured to manage a plurality of vehicle platforms, and a plurality of vehicle cabin units that are connectable to and separable from the vehicle platforms, respectively. The information processing device includes a control unit configured to execute: acquiring demand data indicating a demand for each of the vehicle platforms and the vehicle cabin units; and determining a combination of a first vehicle platform and a first vehicle cabin unit out of the vehicle platforms and the vehicle cabin units based on the demand data.

### CROSS-REFERENCE TO RELATED APPLICATION

The disclosure of Japanese Patent Application No. 2020-140740 filed on Aug. 24, 2020 including the specification, drawings and abstract is incorporated herein by reference in its entirety.

### BACKGROUND

### 1. Technical Field

The present disclosure relates to techniques for providing service using a vehicle.

### 2. Description of Related Art

Attempts are being made to provide service by dispatching autonomous vehicles designed for various usages. For example, WO 2018/230720 discloses an autonomous vehicle configured to include a combination of a vehicle platform (chassis) and a cabin module (vehicle cabin). The autonomous vehicle can meet various demands by replacement of the vehicle cabin.

### SUMMARY

It is expected to implement a service that automatically composes a vehicle suitable for the demand of a user by using a vehicle including a chassis and a vehicle cabin that are separable from each other.

The present disclosure has been made in consideration of the above issue, and it is an object of the present disclosure to provide a user with a vehicle having an appropriate function according to the demand of the user.

A first aspect of the present disclosure relates to an information processing device configured to manage a plurality of vehicle platforms, and a plurality of vehicle cabin units that are connectable to and separatable from the vehicle platforms, respectively.

Specifically, the information processing device includes a control unit configured to execute:

acquiring demand data indicating a demand for each of the vehicle platforms and the vehicle cabin units; and determining a combination of a first vehicle platform and a first vehicle cabin unit out of the vehicle platforms and the vehicle cabin units based on the demand data.

A second aspect of the present disclosure relates to a method of information processing performed by the information processing device.

Specifically, the method includes: acquiring demand data indicating a demand for each of the vehicle platforms and the vehicle cabin units; and determining a combination of a first vehicle platform and a first vehicle cabin unit out of the vehicle platforms and the vehicle cabin units based on the demand data.

As another aspect, there may be a program for causing a computer to execute the method of information processing executed by the information processing device, or a non-transitory computer readable storage medium storing the program.

The present disclosure can provide a user with a vehicle having an appropriate function according to the demand.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG 1. shows overall configuration of a vehicle system according to an embodiment;

FIG. 2 shows an external appearance of a vehicle according to the embodiment;

FIG. 3 shows system configuration of a server device;

FIG. 4A shows examples of chassis data and vehicle cabin data stored in the server device;

FIG. 4B shows examples of chassis data and vehicle cabin data stored in the server device;

FIG. 5 illustrates an operation plan for a vehicle;

FIG. 6 shows system configuration of a vehicle cabin unit and a chassis unit;

FIG. 7 illustrates a vehicle allocation request that the server device acquires;

FIG. 8 is a flowchart of a process executed by the server device;

FIG. 9 is an explanatory view of a rental period of the chassis unit and the vehicle cabin unit; and

FIG. 10 is a flowchart of a process executed by the vehicle.

### DETAILED DESCRIPTION OF EMBODIMENTS

An information processing device according to an embodiment is a device that manages a vehicle having a chassis part and a body part separable from each other. The information processing device dynamically determines a combination of a chassis and a body based on a demand for the vehicle. It becomes possible to satisfy various demands of users by mounting one or more bodies (hereinafter, vehicle cabin units) on the chassis (hereinafter, vehicle platform).

The vehicle platform in the present disclosure is, for example, a mobile object including a plurality of wheels and motive power. The vehicle platform may have a function to travel, and may not necessarily need to include any habitable room. The vehicle platform is configured to be mountable with any of a plurality of vehicle cabin units different in function. It becomes possible to compose the vehicle used for a prescribed use by mounting a prescribed vehicle cabin unit on a vehicle platform. It is also possible to change the use of the vehicle by separating the mounted vehicle cabin unit and replacing it with another vehicle cabin unit.

Examples of vehicle cabin units that can be mounted on the vehicle platform may include a unit for carrying passengers, a unit for carrying cargos, a unit having a function as a store or a restaurant, or a unit having a function as a habitable room.

The information processing device according to the present embodiment manages a plurality of vehicle platforms and a plurality of vehicle cabin units that are connectable to and separable from the vehicle platforms. Specifically, the information processing device includes a control unit configured to execute: acquiring demand data indicating a demand for each of the vehicle platforms and the vehicle cabin units; and determining a combination of a first vehicle platform and a first vehicle cabin unit out of the vehicle platforms and the vehicle cabin units based on the demand data.

The information processing device determines a combination of the vehicle platform and the vehicle cabin unit to be provided to the user based on the demand data. The demand data indicates the demand of the user for the vehicle. The demand data may indicate the demand for the vehicle platform, or may indicate the demand for the vehicle cabin unit. The demand data may include both the demands. The demand data may be acquired in the form of a request from the user, or may be generated based on other information transmitted from the user. Since a combination of the vehicle platform and the vehicle cabin unit is determined based on the demand data, it becomes possible to provide the user with the vehicle (a chassis, a vehicle cabin, or both the chassis and the vehicle cabin) having a function desired by the user.

The vehicle cabin units may have any of two or more different attributes, and the control unit may select a first vehicle cabin unit having the attribute indicated in the demand data. For example, the attribute of the vehicle cabin unit may be associated with the function of the vehicle cabin unit. The vehicle system according to the present embodiment may set, as management targets, a plurality of vehicle cabin units that function as, for example, retail stores, restaurants, lodging facilities, conference rooms, or the like. The vehicle system may set, as management targets, a plurality of vehicle cabin units having functions relating to passenger transportation or cargo transportation.

The vehicle platforms may have any of two or more different attributes, and the control unit may select the first vehicle platform having the attribute indicated in the demand data. For example, the attributes of the vehicle platforms may be associated with the capacity of the vehicle platforms. The vehicle system according to the present embodiment can set, as management targets, a plurality of vehicle platforms. The vehicle platforms are each different in traveling capacity (battery capacity, cruising range, maximum output, etc.) and in capacity for loading the vehicle cabin units, or the like.

The attributes indicated by the demand data may be specified directly or may be specified indirectly.

The control unit may acquire the demand data from a user device used by the user. The demand data can be acquired from a device such as a terminal, a computer, or a server device used by the user through networks.

The control unit may generate an operation plan of the first vehicle platform based on the determined combination. For example, the first vehicle platform may be connected to the first vehicle cabin unit, and be sent to the user in accordance with the generated operation plan. Thus, both the vehicle platform and the vehicle cabin unit can be sent to the user.

The operation plan may include a first operation plan for connecting the first vehicle platform to the first vehicle cabin unit, and a second operation plan for sending the first vehicle platform to the user. When the vehicle platform and the vehicle cabin unit are separated in an initial state, it is necessary to connect the vehicle platform and the vehicle cabin unit. The first operation plan is for connecting the vehicle platform, which is not yet connected, to the target vehicle cabin unit. The second operation plan is for sending the vehicle after connection to the user.

The operation plan may also include a first operation plan for connecting the first vehicle platform to the first vehicle cabin unit, a second operation plan for sending the first vehicle cabin unit to the user, and a third operation plan for collecting the first vehicle cabin unit. When the user uses only the vehicle cabin unit, the vehicle platform can be used for another use during the period of use.

The control unit may also periodically acquire location data indicating the locations of the vehicle platforms and the vehicle cabin units. The control unit may also generate the first operation plan based on the location data. Based on the location data, the information processing device can determine an optimal combination of a vehicle platform and a vehicle cabin unit to be dispatched to the user, and an operation route of the vehicle platform, or the like.

The control unit may generate an operation instruction for operating the first vehicle platform based on the operation plan. The operation instruction is a command for the vehicle platform to move or travel based on the operation plan. When the vehicle platform is made to operate based on the operation instruction, the vehicle platform or the vehicle cabin unit can be sent to the user.

Hereinafter, the embodiment of the present disclosure will be described with reference to the drawings. The configuration of the embodiment described below is merely illustrative, and therefore the present disclosure is not limited to the configuration of the embodiment.

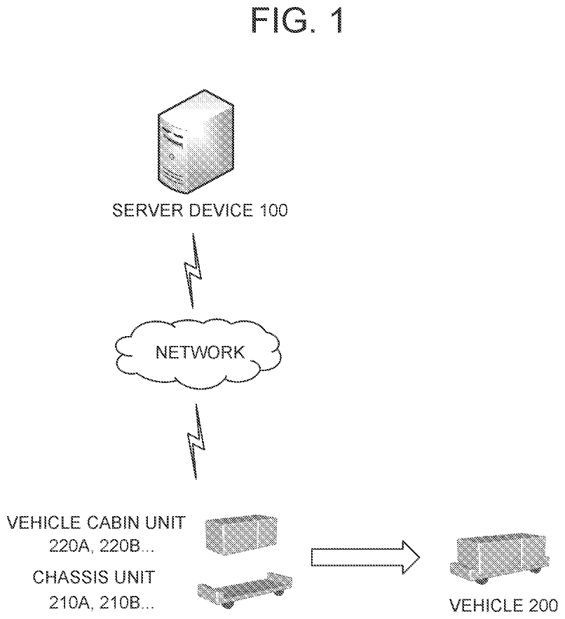

An outline of the vehicle system according to the embodiment will be described with reference to FIG. 1. The vehicle system according to the present embodiment is configured to include one or more vehicles 200 that perform autonomous travel based on given instructions, and a server device 100 that issues the instructions.

The vehicles 200 are configured such that a chassis part and a body part can be separated. Hereinafter, the chassis part is referred to as a chassis unit 210, and the body part is referred to as a vehicle cabin unit 220. In the vehicle system according to the present embodiment, the server device 100 manages the chassis units 210 that are different in attributes and the vehicle cabin units 220 that are different in attributes. The chassis units 210 are each configured to be loadable with any of the vehicle cabin units 220. Thus, it is possible to compose the vehicle 200 having a function desired by a user.

The chassis unit 210 is a mobile object (electric vehicle) having wheels.

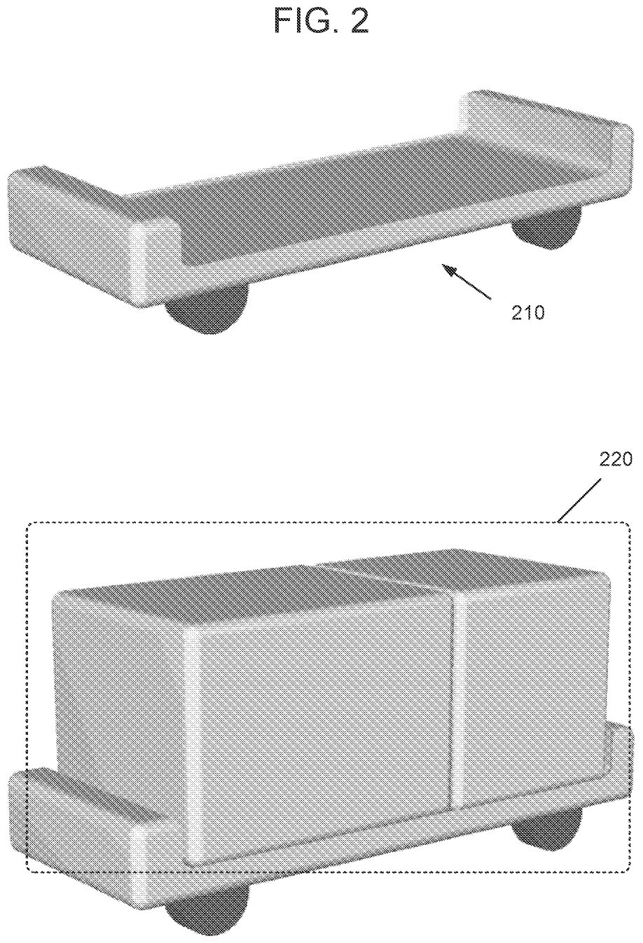

The chassis unit 210 has a chassis shape without a vehicle cabin part, and therefore, the chassis unit 210 can be loaded with an optional vehicle cabin unit 220. FIG. 2 is an external view showing an example of the chassis unit 210 loaded with the vehicle cabin unit 220. The chassis unit 210 can also be referred to as a vehicle platform. The chassis unit 210 may not necessarily be a vehicle that can perform a completely autonomous travel. For example, the chassis unit 210 may be a vehicle that is driven by a person or driven with assistance given by the person in accordance with situations. The chassis unit 210 can be connected to or separated from the vehicle cabin unit 220 in a prescribed operation base. The operation base can store the chassis units 210 and the vehicle cabin units 220 which are not in operation.

The vehicle cabin unit 220 has space for exhibiting a prescribed function. In the vehicle system, the vehicle cabin units 220 specialized in providing prescribed services provide the services to the users. Examples of the prescribed services may include the followings.
Passenger or cargo transportation service
Retail service
Restaurant service
Lodging service
Rental space

For example, the vehicle cabin unit 220 including equipment, such as seats, tables, air conditioning equipment, or AV equipment, can provide the passenger transportation service. For example, the vehicle cabin unit 220 including equipment, such as equipment for fixing containers and boxes, shock absorbing devices, refrigerating equipment, or freezing equipment, can provide the cargo transportation service. The vehicle cabin unit 220 including equipment, such as guest seats, kitchens, refrigerators, or water section equipment, can provide the restaurant service.

In the aforementioned examples, the vehicle cabin unit 220 is loaded on the chassis unit 210. However, as long as the chassis unit 210 and the vehicle cabin unit 220 can be connected by any prescribed methods, the vehicle cabin unit 220 may not necessarily need to be loaded on the chassis unit 210.

The method of connecting the chassis unit 210 and the vehicle cabin unit 220 is not limited to specific methods. For example, they may be connected and separated mechanically with use of a locking mechanism or the like, or may be connected and separated by using an electromagnet or the like. Examples of the method of loading or unloading the vehicle cabin unit 220 on or from the chassis unit 210 may include a method using a dedicated lift, and a method using a mechanism included in the chassis unit 210 or in the vehicle cabin unit 220 itself. The method of loading or unloading the vehicle cabin unit 220 on or from the chassis unit 210 is not limited to specific methods.

In the present embodiment, the chassis unit 210 includes a lift that can autonomously pick up and drop off any vehicle cabin units 220.

The server device 100 is for managing operation of the vehicles 200. As described before, the vehicle cabin units 220 have a plurality of types for every function. Hence, it is needed to select an appropriate combination to compose the vehicle 200 that is desired by the user.

For example, when there is a user who wishes to do business using a retail store at a certain location point (i.e., who wishes to rent the vehicle cabin unit 220 having the function of a retail store), it is necessary to load the vehicle cabin unit 220 having the function of a store on the chassis unit 210, and head for a specified point. When there are a plurality of users who wish to move by a ride-sharing vehicle, it is necessary to load the vehicle cabin unit 220 having a function of passenger transportation on the chassis unit 210, and to travel along a specified route. It is further necessary to select the chassis unit 210 having an appropriate battery remaining amount in accordance with a necessary traveling distance.

The server device 100 determines to load which vehicle cabin unit 220 onto which chassis unit 210, and determines an operation route (hereinafter, referred to as an operation plan) depending on the demand of the user or users. The server device 100 also issues a specific instruction for implementing the operation plan to the chassis unit 210.

The server device 100, the vehicle cabin units 220, and the chassis units 210 are mutually connected through a network. As the network, wide area networks, such as the Internet, or other communication networks may be adopted. The network may also include mobile communication networks for cellular phones or the like, and wireless communication networks such as Wi-Fi (registered trademark).

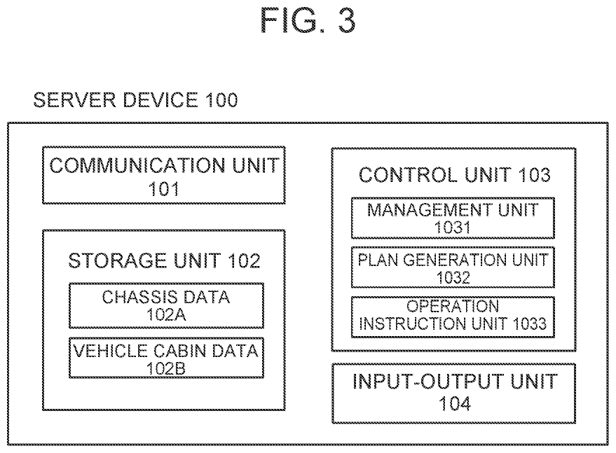

Description is now given of the details of the server device 100. FIG. 3 shows the system configuration of the server device 100. The server device 100 is configured to include a communication unit 101, a storage unit 102, a control unit 103, and an input-output unit 104.

The server device 100 is constituted of a general computer. Specifically, the server device 100 is a computer including a processor such as a CPU or a GPU, a primary storage unit such a RAM or a ROM, and an auxiliary storage unit such as an EPROM, a hard disk drive, or a removable medium. The removable medium may be a USB memory or a disc recording medium such as a CD or a DVD, for example. The auxiliary storage unit stores an operating system (OS), various programs, various tables, and the like. When the programs stored in the auxiliary storage unit are loaded onto a work area of the main storage unit and executed therein, the functions matched with prescribed purposes can be implemented. However, some or all of the functions may be implemented by a hardware circuit such as an ASIC or an FPGA. The server device 100 may be constituted of a single computer, or may be constituted of a plurality of computers which are in cooperation with each other.

The communication unit 101 is a communication interface for connecting the server device 100 to the networks. The communication unit 101 is configured to include, for example, a network interface board and a wireless communication circuit for wireless communication.

The storage unit 102 is configured to include a primary storage unit and an auxiliary storage unit. The primary storage unit is a memory where programs executed by the control unit 103 and data used by the control program thereof are expanded. The auxiliary storage unit is a device that stores programs executed in the control unit 103 and data used by the control program thereof.

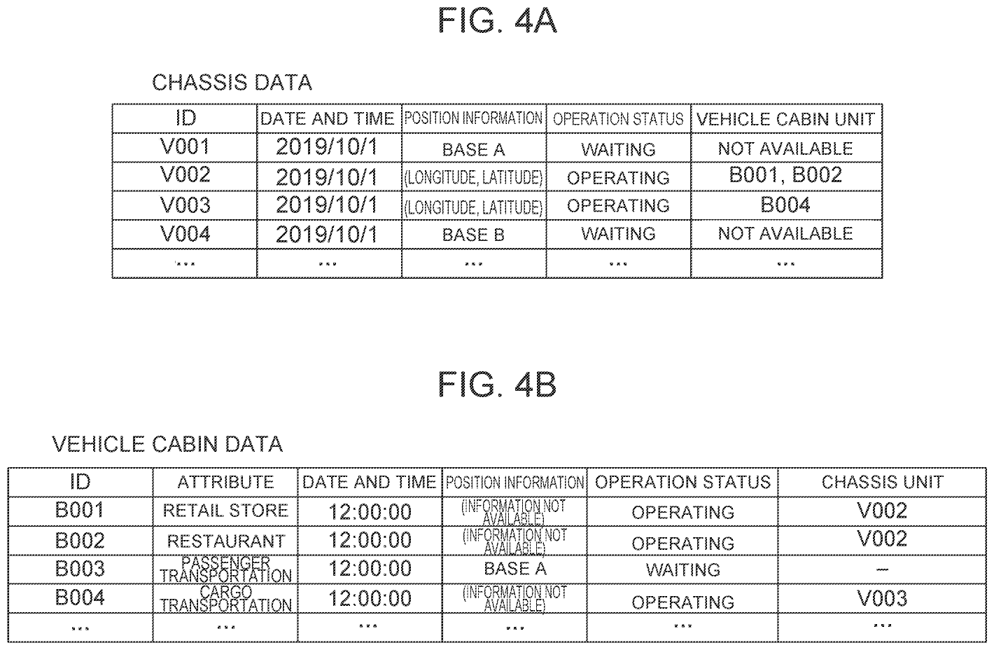

The storage unit 102 further stores chassis data 102A and vehicle cabin data 102B. The chassis data 102A is for managing the chassis units 210. FIG. 4A is an example of the chassis data. The chassis data is data in which identifiers, position information, states, and the like, relating to the chassis units 210 managed by the server device 100 are described. The chassis data may also include information other than these data. For example, the chassis data may include information relating to the owners of the chassis units 210, and waiting points (garages and service offices). The chassis data may also include information relating to vehicle body size, load capacity, travelable distance when fully charged, travelable distance at current time, tasks currently being executed, identifiers of the loaded vehicle cabin units 220, and the like. The chassis data is periodically updated based on the information transmitted from the chassis units 210.

The vehicle cabin data 102B is for managing the vehicle cabin units 220. FIG. 4B is an example of the vehicle cabin data. The vehicle cabin data is data in which identifiers, position information, states, and the like, relating to the vehicle cabin units 220 managed by the server device 100 are described. The vehicle cabin data may also include information other than these data. For example, the vehicle cabin data may include information relating to the owners, attributes (providable services or functions), and waiting points (garages and service offices) of the vehicle cabin units 220, and information relating to the identifiers of the chassis units 210 loaded with the vehicle cabin units 220. The vehicle cabin data are periodically updated based on the information transmitted from the vehicle cabin units 220.

A database that stores these data are constructed when the program of a database management system (DBMS), which is executed by the processor, manages the data stored in the storage unit. The database used in the present embodiment is a relational database, for example.

The control unit 103 is an arithmetic device that administers the control performed by the server device 100. The control unit 103 may be implemented by an arithmetic processing device, such as a CPU. The control unit 103 is configured to include three functional modules: a management unit 1031; a plan generation unit 1032; and an operation instruction unit 1033. The function modules may each be implemented by executing programs, stored in the auxiliary storage unit, on the CPU.

The management unit 1031 periodically communicates with the chassis units 210 to collect information relating to the status of the chassis units 210 (hereinafter, status information). The collected status information is reflected upon the chassis data 102A. The management unit 1031 also periodically communicates with the vehicle cabin units 220 to similarly collect status information. The collected status information is reflected upon the vehicle cabin data 102B.

As the demand data, the plan generation unit 1032 acquires a vehicle allocation request from a user, and generates a plan (hereinafter, an operation plan) to operate the chassis unit 210 based on the vehicle allocation request. The plan generation unit 1032 determines a combination of a chassis unit and a vehicle cabin unit to be provided to the user, out of the chassis units 210 and the vehicle cabin units 220 which are under management. The plan generation unit 1032 further makes a plan regarding a travel route of the chassis unit 210 and tasks to be executed by the chassis unit 210.

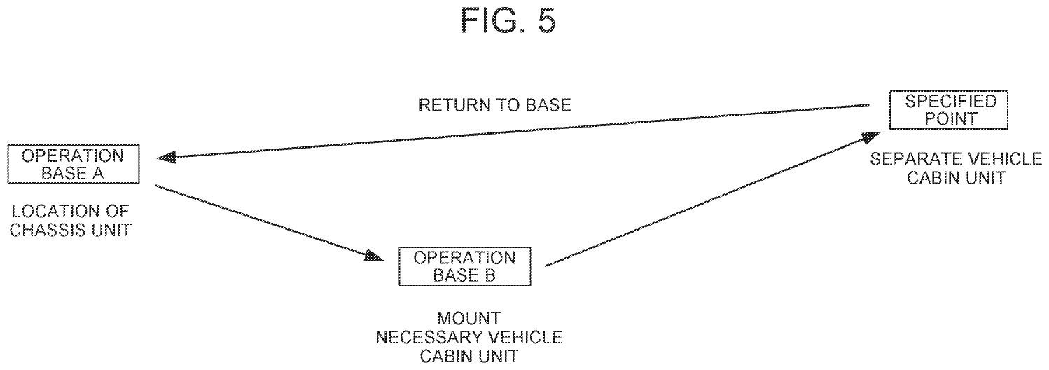

FIG. 5 illustrates an operation plan. The illustrated operation plan includes the followings.
(1) The chassis unit 210 located in an operation base A is made to travel to an operation base B.
(2) In the operation base B, the chassis unit 210 is loaded with the vehicle cabin unit 220 located in the operation base B.
(3) The chassis unit 210 is made to travel to a point specified by the user.
(4) The chassis unit 210 is separated from the vehicle cabin unit 220.
(5) The chassis unit 210 is made to travel to the operation base A.

The operation instruction unit 1033 generates an instruction (operation instruction) to be transmitted to the chassis unit 210 based on the generated operation plan. The operation instruction is a command for executing a plurality of tasks in order to implement the operation plan. The chassis unit 210 operates in accordance with the operation instruction generated by the operation instruction unit 1033.

The input-output unit 104 is an interface that presents information to the administrator of the server device 100 (typically a business operator who operates the vehicle) and that also acquires information. The input-output unit 104 is configured to include a display device or a touchscreen panel, for example.

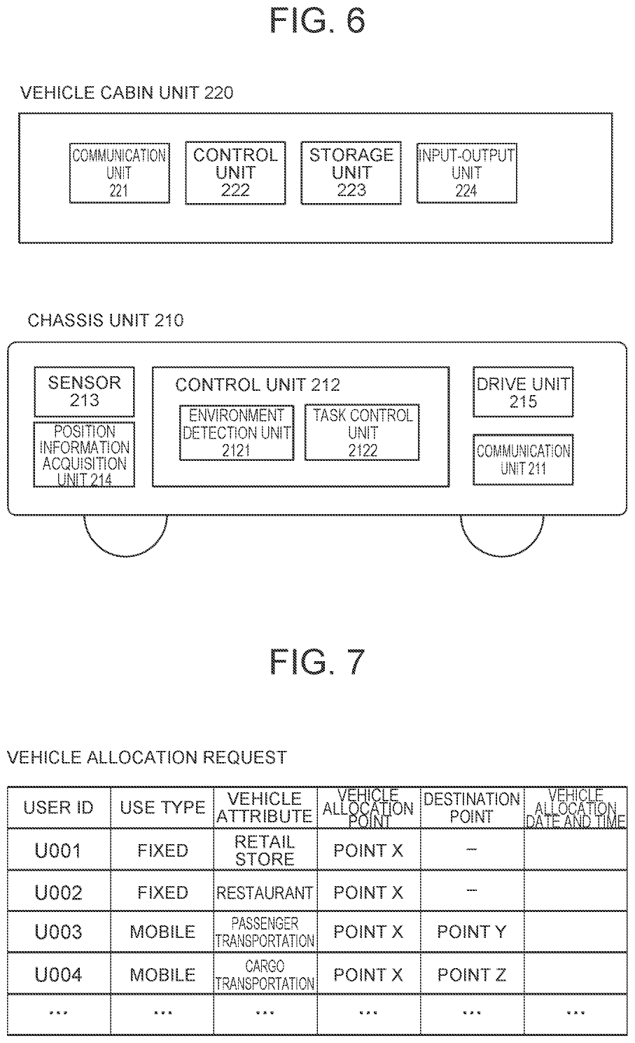

FIG. 6 shows system configuration of the vehicle cabin unit 220 and the chassis unit 210. The vehicle cabin unit 220 is configured to include a communication unit 221, a control unit 222, a storage unit 223, and an input-output unit 224. The vehicle cabin unit 220 operates with electric power supplied from a battery.

The communication unit 221 is communication means for connecting the vehicle cabin unit 220 to the network. In the present embodiment, the communication unit 221 can communicate with the server device 100 and the chassis unit 210 through the network using mobile communications service, such as 4G, LTE, or 5G.

The control unit 222 is a computer that controls operation of the vehicle cabin unit 220. The control unit 222 is constituted of a microcomputer, for example. The control unit 222 may be implemented by executing programs, stored in the storage means such as a ROM, on the CPU. The control unit 222 cooperates with the chassis unit 210 (control unit 212) to execute predetermined tasks (for example, a task of guiding the user, or the like).

The storage unit 223, which is means for storing information, is constituted of a storage medium, such as a RAM, a magnetic disk, or a flash memory. The storage unit 223 stores programs executed in the control unit 222 and data used by the programs.

The input-output unit 224 is an interface for information input and output for the user. The input-output unit 224 is configured to include a display device or a touchscreen panel, for example. When, for example, the vehicle cabin unit 220 is a unit of passenger transportation, information may be provided to passengers through the input-output unit 224. The input-output unit 224 may further be configured to allow input and output of information for user authentication.

Next, the chassis unit 210 will be described. The chassis unit 210 is a vehicle platform that travels in response to an operation instruction acquired from the server device 100. Specifically, the chassis unit 210 generates a travel route based on the operation instruction acquired via wireless communication, and travels on a road by an appropriate method, while sensing the periphery of the vehicle. While traveling along the route, the chassis unit 210 further executes predetermined tasks including connection and separation of the vehicle cabin unit 220.

The chassis unit 210 is configured to include a communication unit 211, a control unit 212, a sensor 213, a position information acquisition unit 214, and a drive unit 215. The chassis unit 210 operates with the electric power supplied from a battery.

The communication unit 211 is a communication interface for communicating with the server device 100 or the vehicle cabin unit 220 through the network. The communication unit 211 may further include communication means for performing vehicle-to-vehicle communication with other vehicles.

The control unit 212 is a computer that controls the chassis unit 210 based on the information acquired from the sensor 213. The control unit 212 is constituted of a microcomputer, for example.

The control unit 212 has an environment detection unit 2121 and a task control unit 2122 as functional modules. The function modules may each be implemented by executing programs, stored in the storage means such as a ROM, on the CPU.

The environment detection unit 2121 detects the peripheral environment based on the data acquired by the sensor 213. Examples of detection targets include the number and position of lanes, the number and position of the vehicles present around the own vehicle, the number and position of obstacles (for example, pedestrians, bicycles, structures, buildings, and the like) present around the own vehicle, the structure of roads, and road signs. However, the detection targets are not limited to these. The detection targets may be any objects as long as the objects are necessary for autonomous travel. The environment detection unit 2121 may also track a detected object. The data about environment (hereinafter, environment data) detected by the environment detection unit 2121 is transmitted to the below-described task control unit 2122.

The task control unit 2122 executes a specified task based on the operation instruction. For example, when the task is to travel to a specified point, the task control unit 2122 controls travel of the own vehicle based on the environment data generated by the environment detection unit 2121 and position information regarding the own vehicle acquired by the position information acquisition unit 214, or the like. For example, the task control unit 2122 makes the own vehicle travel along a prescribed route while preventing obstacles from entering into a prescribed safety area around the own vehicle.

As a method of implementing an autonomous travel of the vehicle, a publicly-known method may be adopted.

The task control unit 2122 executes predetermined tasks on the route and at the destination. Examples of the tasks include “loading and separating the vehicle cabin unit 220”, “picking up or dropping off passengers or cargos in cooperation with the vehicle cabin unit 220”, or “notifying arrival of the vehicle to the user”. However, the tasks are not limited to these.

The sensor 213 is means for sensing the periphery of the vehicle. The sensor 213 is typically configured to include a stereoscopic camera, a laser scanner, a LIDAR, or a radar. The information acquired by the sensor 213 is transmitted to the control unit 212. The sensor 213 is configured to include a sensor used for autonomous travel. The sensor 213 may also include a camera provided in the chassis unit 210. For example, the sensor 213 may include an imaging device using an image sensor, such as a charge-coupled device (CCD), a metal-oxide-semiconductor (MOS), or a complementary metal-oxide-semi conductor (CMOS).

The position information acquisition unit 214 is means for acquiring the current position of the chassis unit 210. The position information acquisition unit 214 is typically configured to include a GPS receiver or the like. The information acquired by the position information acquisition unit 214 is transmitted to the control unit 212.

The drive unit 215 is means for making the chassis unit 210 travel. The drive unit 215 is configured to include, for example, a motor, an inverter, a brake, a steering mechanism, and a secondary battery for driving wheels.

The chassis unit 210 includes mechanisms (an elevator, an actuator, a guide rail, and the like) for picking up or dropping off the vehicle cabin unit 220. These component members are controlled by the task control unit 2122.

Description is now given of the outline of the server device 100. During operation, the vehicle cabin unit 220 and the chassis unit 210 periodically notify their own status information to the server device 100. The server device 100 (management unit 1031) updates the chassis data 102A and the vehicle cabin data 102B based on the notified status information. Shown below are examples of the status information to be transmitted. The status information is also referred to as location data.

Chassis Unit 210

Position information
Attribute, size, weight, the number, and the like, of connectable vehicle cabin units
Identifier of the vehicle cabin unit currently connected
Current battery state of charge (SOC)
Travelable distance
Information about operation route (when the chassis unit is in operation)

Vehicle Cabin Unit 220

Position information
Own Attribute (providable services, or the like)
Attribute of connectable chassis units
Identifier of the chassis unit currently connected
Current battery state of charge (SOC)

Next, the process executed by the server device 100 will be described with specific examples. FIG. 7 shows examples of vehicle allocation requests acquired by the server device 100. The vehicle allocation requests are data for users to request use of vehicles. For example, the vehicle allocation requests are transmitted from the mobile terminals possessed by the users. In the present embodiment, the vehicle allocation requests each include a use type, a vehicle attribute, a vehicle allocation point, a desired vehicle allocation date and time, or the like. When the user desires transportation by the vehicle 200, the vehicle allocation request may include a point used as a moving destination.

The use type indicates a division defining whether the user uses the vehicle in a stopped state, or in a moving state. For example, when the user wants to use the vehicle that functions as a store, the use type is “fixed”. When the user wants to use the vehicle for transportation of passengers, the use type is “mobile”.

The vehicle attribute indicates the attribute of a desired vehicle. The vehicle attribute may be, for example, an attribute associated with the vehicle cabin unit such as “retail store” and “restaurant”, or may be an attribute associated with the combination of the vehicle cabin unit and the chassis unit such as “passenger transportation” and “cargo transportation”. The vehicle attribute may also specify the service, capacity, performance, or the like, that the chassis unit 210 or the vehicle cabin unit 220 can provide. The vehicle allocation point and the vehicle allocation date and time are the point and the date and time for allocating the vehicle 200. When the use type is “mobile”, the vehicle allocation point and the vehicle allocation date and time are the point and the date and time for starting movement.

The server device 100 determines a combination of the chassis unit 210 to be dispatched and the vehicle cabin unit 220 to be loaded on the chassis unit 210, based on a vehicle allocation request. It is possible to determine which chassis unit 210 is combined with which vehicle cabin unit 220, based on the chassis data and the vehicle cabin data. For example, the vehicle cabin unit 220 which is in the vicinity of a point specified by the user and which can provide a specified service is selected to be combined with the chassis unit 210 which can go to and come back from the specified point and which can be loaded with the vehicle cabin unit 220.

Next, the server device 100 generates an operation plan of the chassis unit 210 to respond the vehicle allocation request. As described before with reference to FIG. 5, the operation plan is the data indicating the route along which the chassis unit 210 is made to travel and the tasks that the chassis unit 210 are made to execute. Finally, the server device 100 generates an operation instruction to the corresponding chassis unit 210 based on the generated operation plan, and transmits the instruction to the chassis unit 210.

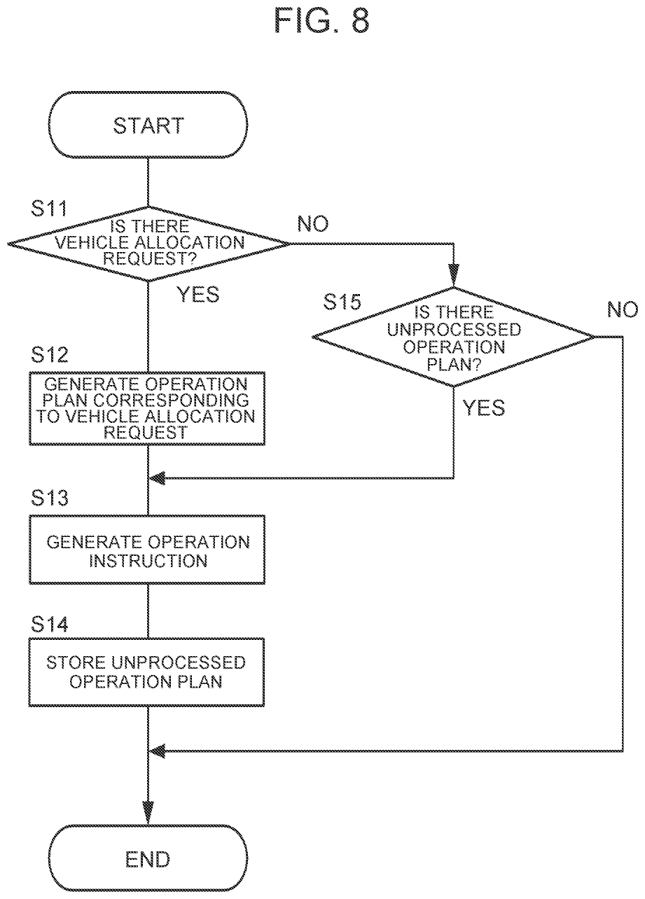

Next, the aforementioned process will be described more in detail with reference to a flowchart. FIG. 8 is the flowchart of the process for the server device 100 to generate an operation instruction based on the vehicle allocation request.

As described before, during operation, the chassis unit 210 and the vehicle cabin unit 220 generate information (status information) regarding their own status, and periodically send the information to the server device 100. The server device 100 (management unit 1031) updates the database based on the received status information. With the process, the server device 100 can recognize the locations of the chassis units and the vehicle cabin units under management.

When a plurality of user terminals transmit vehicle allocation requests to the server device 100, the server device 100 (plan generation unit 1032) receives these requests. When there is a request or requests transmitted from a user or users (step Sll-Yes), the process proceeds to step S12. When there is no vehicle allocation request (step S11-No), the process proceeds to step S15 (described later).

In step S12, the plan generation unit 1032 generates an operation plan of the chassis unit 210 based on the acquired vehicle allocation request.

In this step, a combination of the chassis unit 210 and the vehicle cabin unit 220 that is dispatched to the user is determined based on the vehicle allocation request by the method described before. The chassis unit 210 and the vehicle cabin unit 220 dispatched to the user can be determined with reference to, for example, the chassis data and the vehicle cabin data.

Next, an operation plan is generated for the determined chassis unit 210. The operation plan includes the travel route of the chassis unit 210, the operation base where the vehicle cabin unit 220 is loaded, as well as the identifier, the travel route, and the destination of the vehicle cabin unit 220 to be loaded on the chassis unit 210.

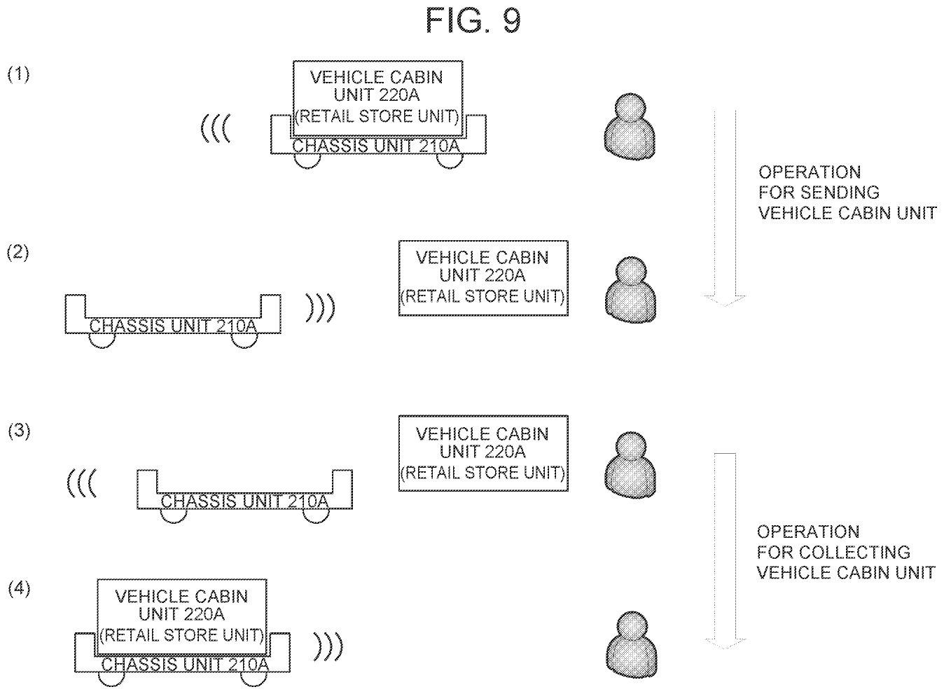

When the use type included in the vehicle allocation request is “fixed”, it is sufficient to lend only the vehicle cabin unit 220 to the user. In this case, the chassis unit 210 may be separated during the rental period. FIG. 9 illustrates the rental period when the use type is “fixed”. As illustrated, when a vehicle cabin unit 220A has the function of a store, it is not necessary to keep the chassis unit 210 at the location of the user during the rental period. For example, during the rental period, the chassis unit 210 can be separated and allocated to another business. In short, the vehicle cabin unit 220A and the chassis unit 210 may have different rental periods. In such a case, an operation plan for sending the vehicle cabin unit 220 to the user and an operation plan for collecting the vehicle cabin unit 220 may be generated individually. Thus, when the chassis unit 210 is separated during the rental period of the vehicle cabin unit 220, it is possible to increase the operating rate of the chassis unit 210.

Moreover, the vehicle allocation request and the operation plan may be in many-to-one relation instead of one-to-one relation. For example, when the vehicle allocation request is to request movement by a ride-sharing vehicle, a plurality of vehicle allocation requests (i.e., riding requests) transmitted from passengers within a prescribed period may be integrated, and an operation plan for one vehicle may be generated.

In step S13, the operation instruction unit 1033 generates an operation instruction that defines the task to be performed by the chassis unit 210 based on the generated operation plan, and transmits the operation instruction to the chassis unit 210.

As described before, there are cases where a plurality of operation plans are generated for one vehicle allocation request. For example, there is a case where the vehicle cabin unit 220 is sent to the user, and then only the chassis unit 210 comes back. In this case, operation of the chassis unit 210 is temporarily ended. However, in this case, when the time of returning the vehicle cabin unit 220 comes, it is needed to send the chassis unit 210 to the user again. This means that the server device 100 needs to generate two operation instructions. In step S14, the server device 100 determines whether there is any unprocessed operation plan that is needed to be processed at some point of time in the future. When there is an unprocessed operation plan, the server device 100 temporarily stores the unprocessed operation plan.

When there is no vehicle allocation request in step S11, the process shifts to step S15 to process any unprocessed operation plan. When there is an unprocessed operation plan, the process shifts to step S13 to generate a corresponding operation instruction. For example, the server device 100 generates an operation instruction including a task to collect the vehicle cabin unit 220 from the user, and transmits the operation plan to the chassis unit 210.

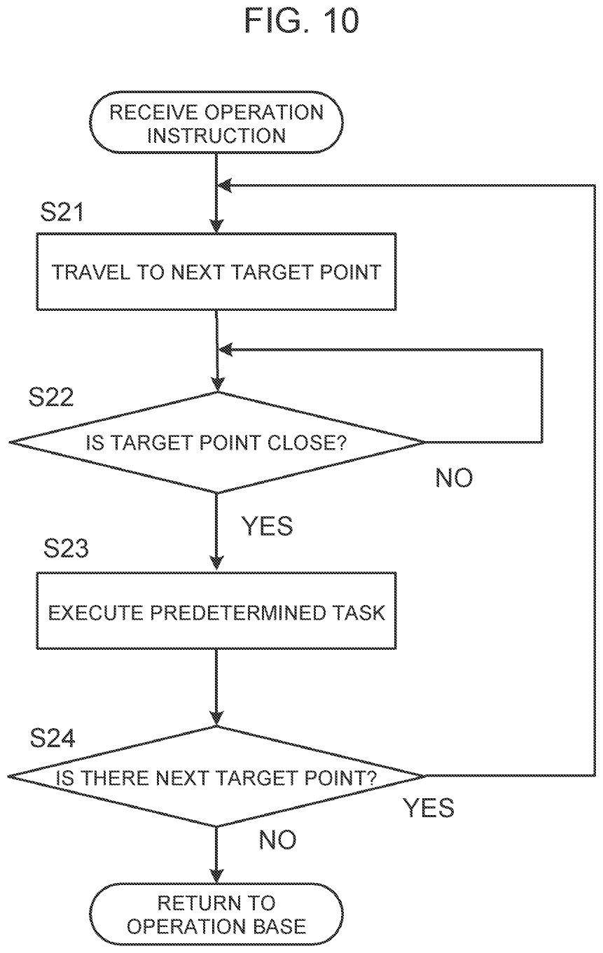

FIG. 10 is a flowchart of a process performed by the chassis unit 210 upon reception of an operation instruction.

In step S21, the task control unit 2122 starts a travel to a target point based on the generated operation instruction. The status information is periodically transmitted to the server device 100 even during operation.

When the target point becomes closer (step S22), the task control unit 2122 searches for a place where the chassis unit 210 can stop in the vicinity of the target point, and stops at the searched place to execute a predetermined task specified by the operation instruction (step S23). For example, the predetermined task may be loading and separating the vehicle cabin unit 220, picking up or dropping off passengers, picking up or dropping off cargos, and calling the user. However, the predetermined task may be other than these. The task may also be executed in cooperation with the control unit 222.

Next, the task control unit 2122 determines the presence of a next target point based on the operation instruction (step S24). When there is a next target point, the task control unit 2122 continues the operation of the chassis unit 210. When the next target point is not present, the chassis unit 210 returns to the operation base.

As described in the foregoing, the present embodiment can dynamically generate a combination of a chassis unit and a vehicle cabin unit and connect the chassis unit and the vehicle cabin based on a user's demand for the vehicle. Thus, it becomes possible to automatically compose the vehicle desired by the user, and send the vehicle to the user.

Modifications

The aforementioned embodiment is merely an example, and the present disclosure can suitably be changed without departing from the scope of the present disclosure. For example, the processes or means described in the present disclosure can freely be combined and implemented without departing from the range of technical consistency.

In the description of the embodiment, the chassis unit 210 is loaded with a single vehicle cabin unit 220. However, the chassis unit 210 may be loaded with a plurality of vehicle cabin units 220.

In the description of the embodiment, the vehicle allocation request transmitted from a user is regarded as demand data. However, the demand data may be generated by an external device.

In the description of the embodiment, the operation plan of the vehicle is generated based on the demand which actually arises. However, the operation plan of the vehicle may be generated based on data made for predicting the demand. For example, an external device may generate the data for predicting a future demand based on past records. In this case, in order to compose a vehicle before the demand actually arises, the server device 100 may issue an instruction (for example, an instruction to load a prescribed vehicle cabin unit 220) to the chassis unit 210 in advance.

The processes described to be performed by one device may be executed by a plurality of devices in cooperation with each other. Alternatively, the processes described to be executed by different devices may be executed by one device. In a computer system, hardware configuration (server configuration) that implements each function may flexibly be changed.

The present disclosure can also be implemented when a computer program, mounted with the functions described in the embodiment, is supplied to a computer, and one or more processors included in the computer read and execute the program. Such a computer program may be provided to the computer by a non-transitory computer readable storage medium that is connectable to a system bus of the computer, or may be provided to the computer through the network. Examples of the non-transitory computer readable storage medium may include a disk or disc of any types, including magnetic disks (such as floppy (registered trademark) disks, and hard disk drives (HDDs)) and optical discs (such as CD-ROMs, DVD discs, and Blu-ray discs), a read-only memory (ROM), a random-access memory (RAM), an EPROM, an EEPROM, a magnetic card, a flash memory, an optical card, or a medium of any types suitable for storing electronic commands.

What is claimed is:

1. An information processing device configured to manage a plurality of vehicle platforms, and a plurality of vehicle cabin units that are connectable to and separable from the vehicle platforms, respectively, the device comprising a control unit configured to execute:
acquiring demand data indicating a demand for each of the vehicle platforms and the vehicle cabin units; and
determining a combination of a first vehicle platform and a first vehicle cabin unit out of the vehicle platforms and the vehicle cabin units based on the demand data.

2. The information processing device according to claim 1, wherein:
the vehicle cabin units have any of two or more different attributes; and
the control unit selects the first vehicle cabin unit having an attribute indicated by the demand data.

3. The information processing device according to claim 2, wherein:
the vehicle platforms have any of two or more different attributes; and
the control unit selects the first vehicle platform having the attribute indicated by the demand data.

4. The information processing device according to claim 2, wherein the control unit acquires the demand data from a user device used by the user.

5. The information processing device according to claim 1, wherein the control unit generates an operation plan of the first vehicle platform based on the determined combination.

6. The information processing device according to claim 5, wherein the operation plan includes a first operation plan for connecting the first vehicle platform to the first vehicle cabin unit, and a second operation plan for sending the first vehicle platform to the user.

7. The information processing device according to claim 5, wherein the operation plan includes a first operation plan for connecting the first vehicle platform to the first vehicle cabin unit, a second operation plan for sending the first vehicle cabin unit to the user, and a third operation plan for collecting the first vehicle cabin unit.

8. The information processing device according to claim 6, wherein the control unit periodically acquires location data indicating locations of the vehicle platforms and the vehicle cabin units.

9. The information processing device according to claim 8, wherein the control unit generates the first operation plan based on the location data.

10. The information processing device according to claim 5, wherein the control unit generates an operation instruction for operating the first vehicle platform based on the operation plan.

11. A method of information processing executed by an information processing device configured to manage a plurality of vehicle platforms, and a plurality of vehicle cabin units that are connectable to and separable from the vehicle platforms, respectively, the method comprising:
acquiring demand data indicating a demand for each of the vehicle platforms and the vehicle cabin units; and
determining a combination of a first vehicle platform and a first vehicle cabin unit out of the vehicle platforms and the vehicle cabin units based on the demand data.

12. The method according to claim 11, wherein
the vehicle cabin units have any of two or more different attributes; and
the first vehicle cabin unit having an attribute indicated by the demand data is selected.

13. The method according to claim 12, wherein:
the vehicle platforms have any of two or more different attributes; and
the first vehicle platform having the attribute indicated by the demand data is selected.

14. The method according to claim 12, wherein the demand data is acquired from a user device used by the user.

15. The method according to claim 11, wherein an operation plan of the first vehicle platform is generated based on the determined combination.

16. The method according to claim 15, wherein the operation plan includes a first operation plan for connecting the first vehicle platform to the first vehicle cabin unit, and a second operation plan for sending the first vehicle platform to the user.

17. The method according to claim 16, comprising periodically acquiring location data indicating locations of the vehicle platforms and the vehicle cabin units.

18. The method according to claim 17, wherein the first operation plan is generated based on the location data.

19. The method according to claim 15, wherein an operation instruction for operating the first vehicle platform is generated based on the operation plan.

20. A program for causing a computer to execute the method of information processing according to claim 11.
